(19) United States
(12) Patent Application Publication
(10) Pub. No.: US 2024/0421529 A1
(43) Pub. Date: Dec. 19, 2024

(54) CONNECTOR

(71) Applicant: YAZAKI CORPORATION, Tokyo (JP)

(72) Inventors: Yoshinori Ishikawa, Makinohara-shi (JP); Kenta Suzuki, Tokyo (JP)

(21) Appl. No.: 18/677,821

(22) Filed: May 29, 2024

(30) Foreign Application Priority Data
Jun. 19, 2023 (JP) 2023-099785

(51) Int. Cl. H01R 13/52; H01R 13/422; H01R 13/506

(52) U.S. Cl. CPC H01R 13/52; H01R 13/422; H01R 13/506

(57) ABSTRACT

A connector includes: a frame including an accommodating chamber; a male terminal; a connector housing holding the male terminal while a tab portion protrudes and inserted into the accommodating chamber; and a tubular protective cover fitted to the connector housing and detached from the connector housing when the connector housing is inserted into the accommodating chamber. The frame includes a guiding portion for positioning that is disposed at an entrance of the accommodating chamber. The protective cover includes a slit-like opening and accommodates the tab portion while fitted to the connector housing. The protective cover includes a groove portion into which the guiding portion is inserted and a releasing rib disposed in the groove portion. The protective cover is deformed by pressing force received by the releasing rib from the guiding portion to widen an opening width of the opening, thereby being detached from the connector housing.

### CROSS-REFERENCE TO RELATED APPLICATION(S)

The present application claims priority to and incorporates by reference the entire contents of Japanese Patent Application No. 2023-099785 filed in Japan on Jun. 19, 2023.

### BACKGROUND OF THE INVENTION

### 1. Field of the Invention

The present invention relates to a connector.

### 2. Description of the Related Art

There is a conventional technique that protects a terminal in a connector. Japanese Patent Application Laid-open No. 2011-119074 discloses a terminal protective cap for a connector. This terminal protective cap for a connector is fitted to a connector including a terminal fitting and a connector housing holding the terminal fitting while a contact portion disposed on its front end side is exposed, and protects the contact portion of the terminal fitting. The terminal protective cap for a connector includes a cap body and an abutting portion disposed on the cap body and abutting on a mating component when the connector is attached to the mating component.

With the above-described terminal protective cap for a connector, the terminal protective cap may be misaligned relative to the mating component. Misalignment of the terminal protective cap prevents correct insertion of the connector housing and the like, which may degrade workability.

### SUMMARY OF THE INVENTION

An object of the present invention is to provide a connector that can improve workability of insertion of a connector housing while protecting a terminal.

In order to achieve the above mentioned object, a connector according to one aspect of the present invention includes a frame including an accommodating chamber; a male terminal including a tab portion; a connector housing including a through hole configured to hold the male terminal while the tab portion protrudes, the connector housing being configured to be inserted into the accommodating chamber while the male terminal is held; and a tubular protective cover configured to be fitted to the connector housing before inserted into the accommodating chamber, and configured to be detached from the connector housing upon insertion of the connector housing into the accommodating chamber, wherein the frame includes a guiding portion for positioning disposed at an entrance of the accommodating chamber, the protective cover includes a slit-like opening extending in an inserting direction in which the connector housing is inserted into the accommodating chamber, and is configured to be deformable to widen an opening width of the opening, the protective cover includes a locking portion configured to lock the connector housing in the inserting direction, and the protective cover defines an accommodating space configured to accommodate the tab portion while fitted to the connector housing, the protective cover includes a groove portion disposed at a tip of the protective cover and into which the guiding portion is inserted, and a releasing rib disposed in the groove portion so as to come into contact with the guiding portion, and the protective cover is configured to be deformed by pressing force received by the releasing rib from the guiding portion to widen the opening width of the opening, and detached from the connector housing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a connector according to an embodiment;

FIG. 2 is an exploded perspective view of a sub-connector according to the embodiment;

FIG. 3 is a perspective view of a frame according to the embodiment;

FIG. 4 is a perspective view of a protective cover according to the embodiment;

FIG. 5 is a diagram describing a cover fitting step of the embodiment;

FIG. 6 is a perspective view of a section of a connector housing and the protective cover;

FIG. 7 is a perspective view of a terminal inserting step of the embodiment;

FIG. 8 is a perspective view of a unit for assembly according to the embodiment;

FIG. 9 is a perspective view of a positioning step of the embodiment;

FIG. 10 is a side view of a detaching step of the embodiment;

FIG. 11 is a perspective view of the detaching step of the embodiment;

FIG. 12 is a sectional view of the protective cover deformed;

FIG. 13 illustrates a section of a connector inserting step of the embodiment; and

FIG. 14 is a diagram illustrating the frame restricting incorrect insertion of the connector housing.

### DETAILED DESCRIPTION OF THE PREFERRED EMBODIMENTS

A connector according to an embodiment of the present invention will be described in detail below with reference to the drawings. Note that this embodiment should not be construed to limit this invention. Furthermore, constituents in the following embodiment include those that can readily be conceived by those skilled in the art or that are substantially the same.

### Embodiment

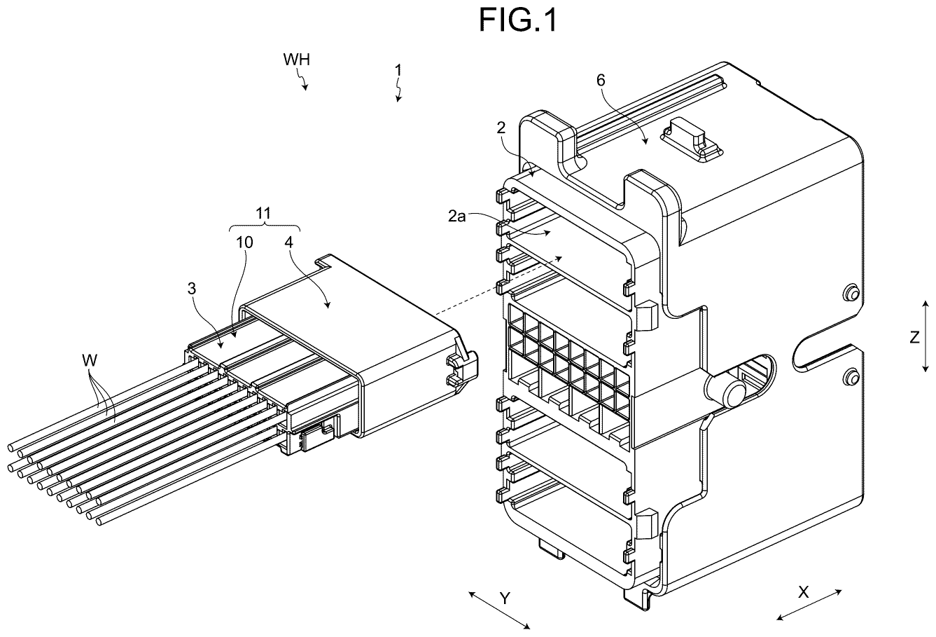

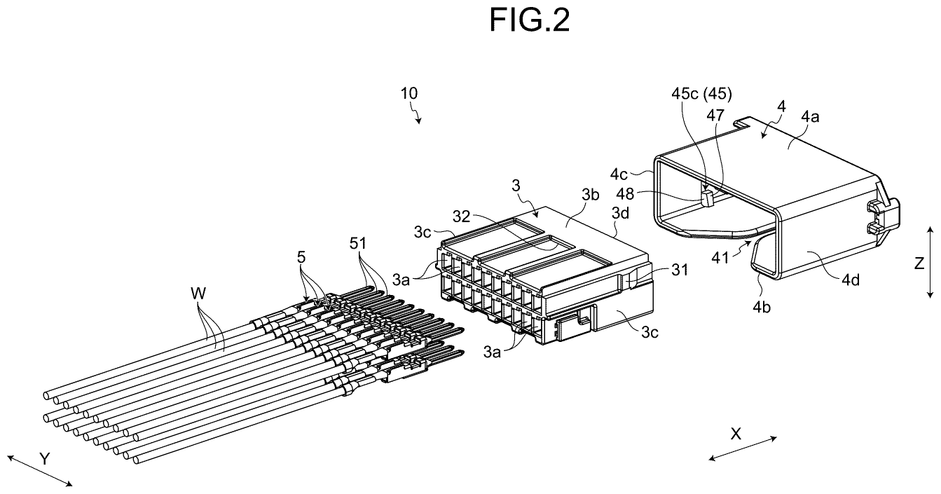

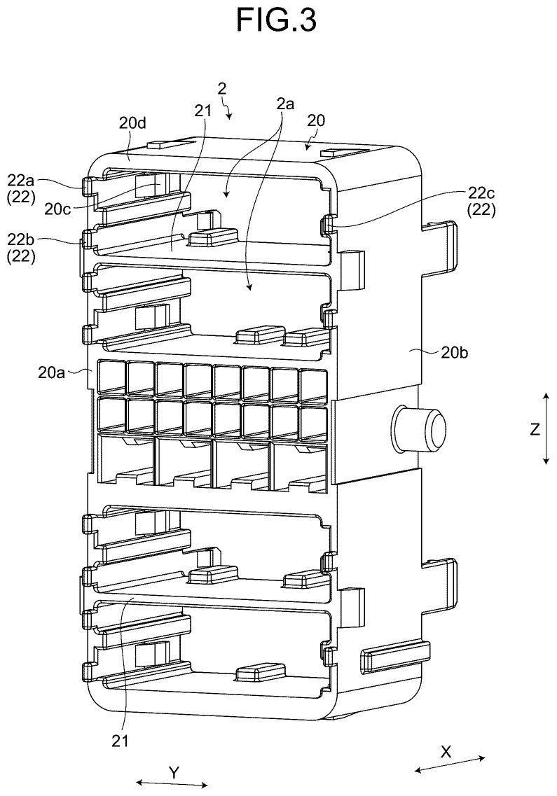

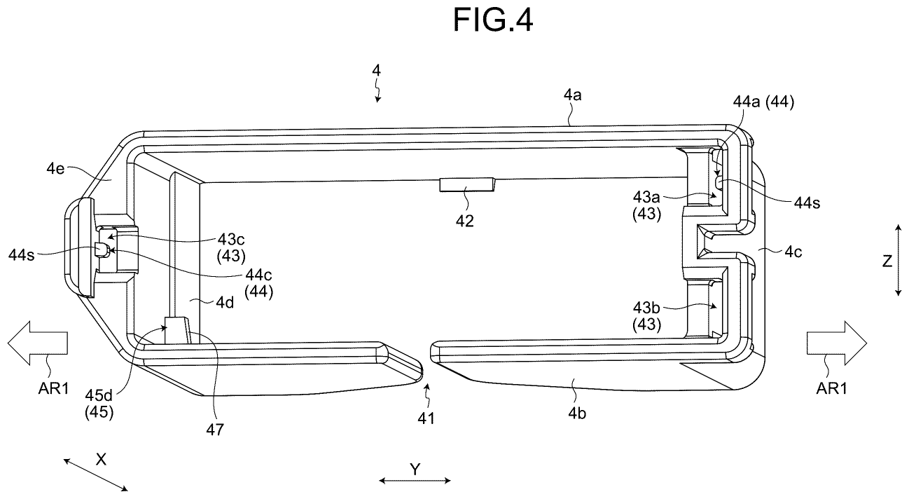

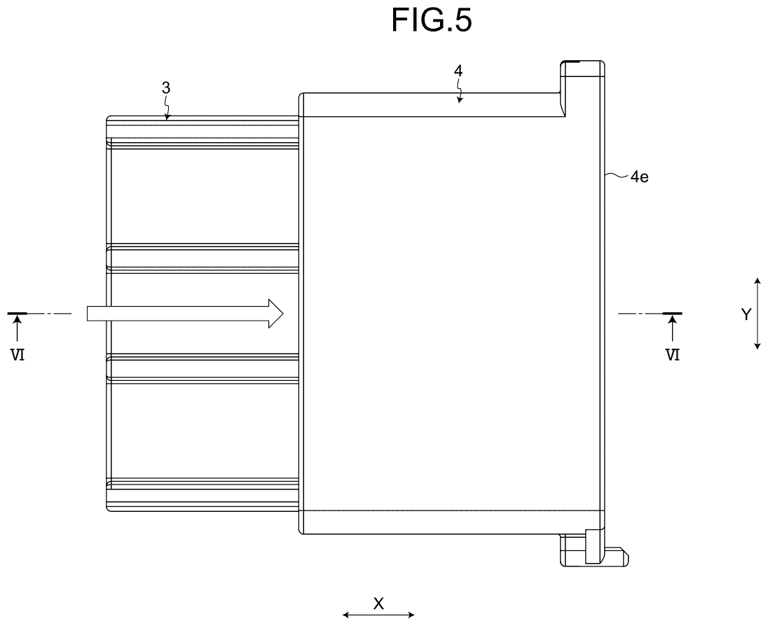

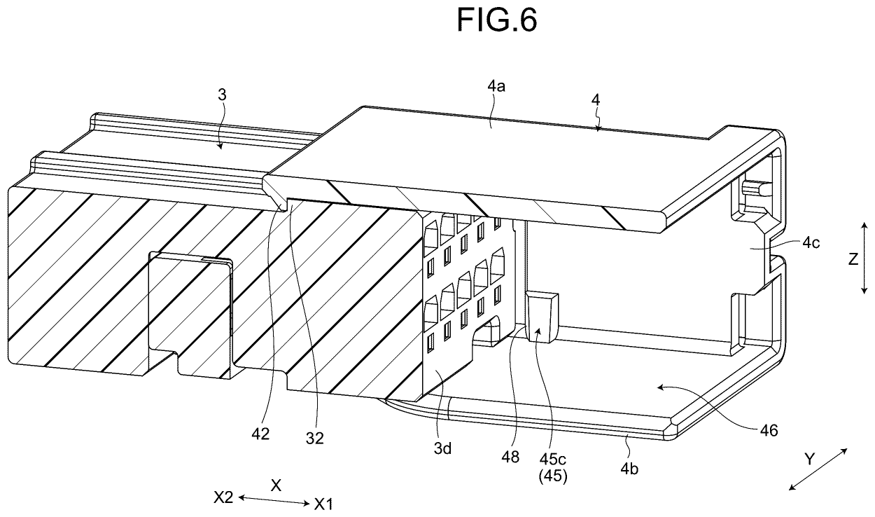

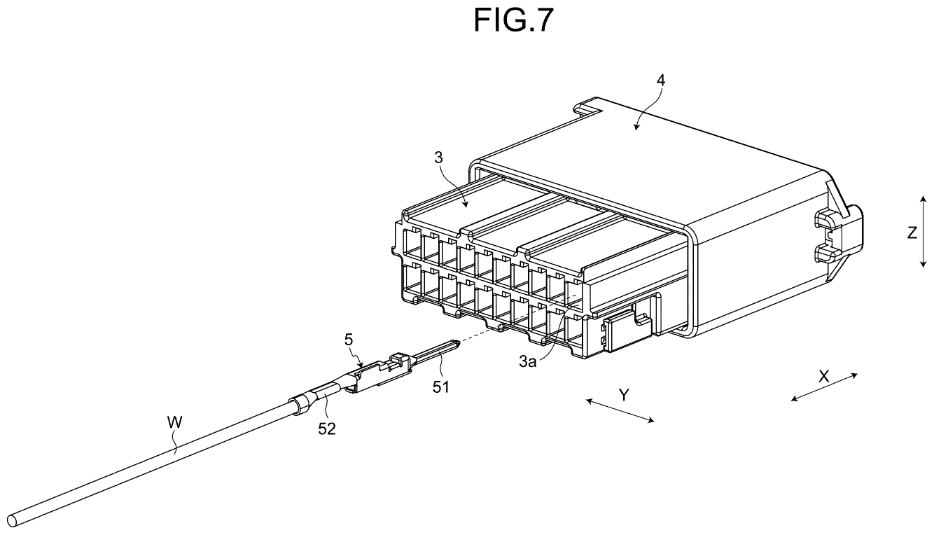

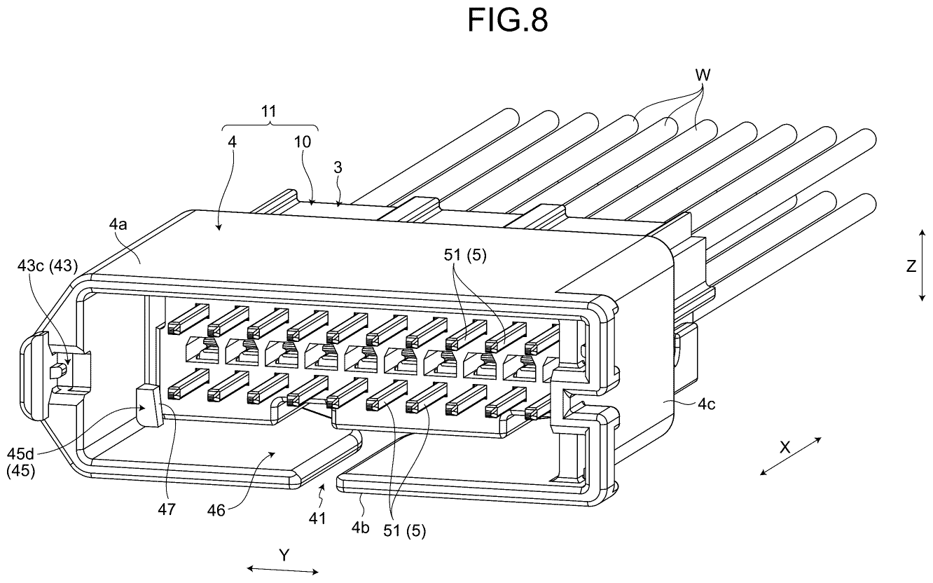

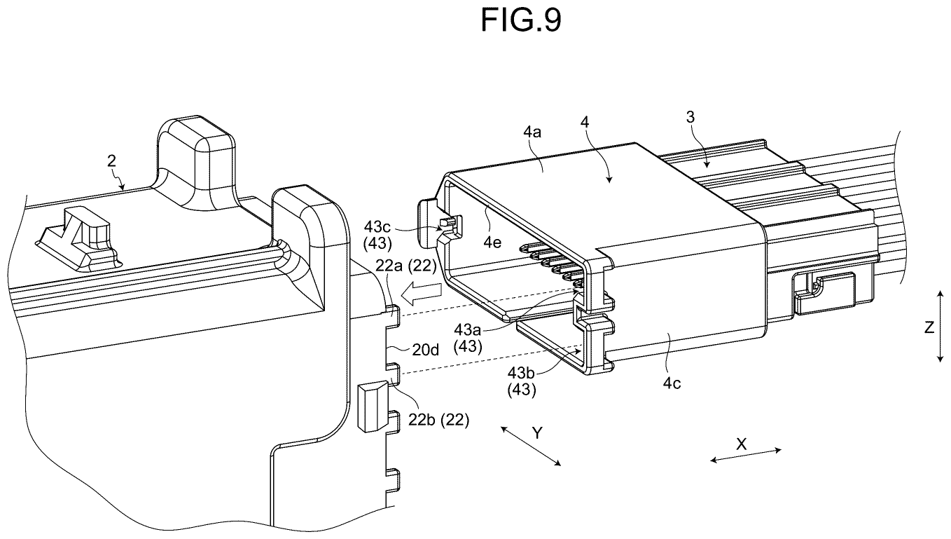

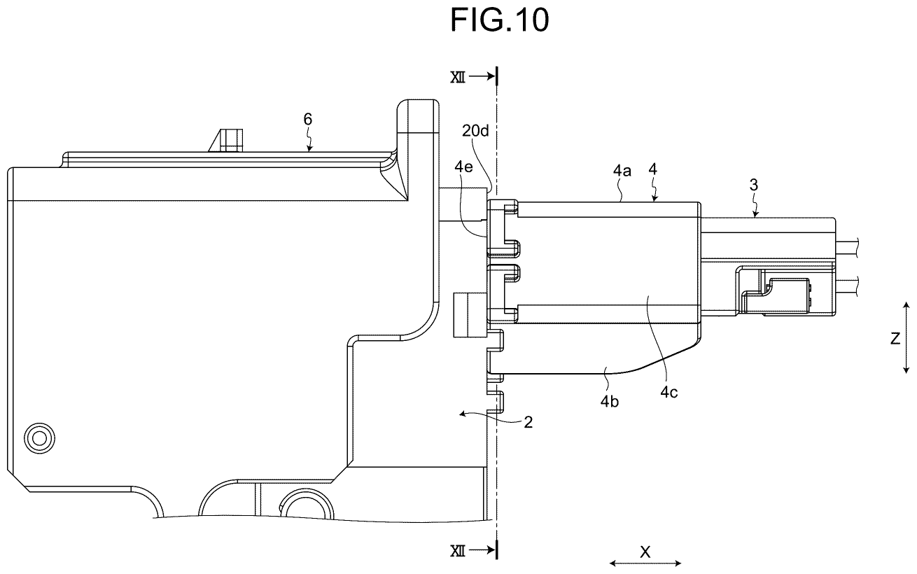

An embodiment will be described with reference to FIGS. 1 to 14. This embodiment relates to a connector. FIG. 1 is a perspective view of a connector according to the embodiment, FIG. 2 is an exploded perspective view of a sub-connector according to the embodiment, FIG. 3 is a perspective view of a frame according to the embodiment, FIG. 4 is a perspective view of a protective cover according to the embodiment, FIG. 5 is a diagram describing a cover fitting step of the embodiment, FIG. 6 is a perspective view of a section of a connector housing and the protective cover, FIG. 7 is a perspective view of a terminal inserting step of the embodiment, FIG. 8 is a perspective view of a unit for assembly according to the embodiment, FIG. 9 is a perspective view of a positioning step of the embodiment, and FIG. 10 is a side view of a detaching step of the embodiment.

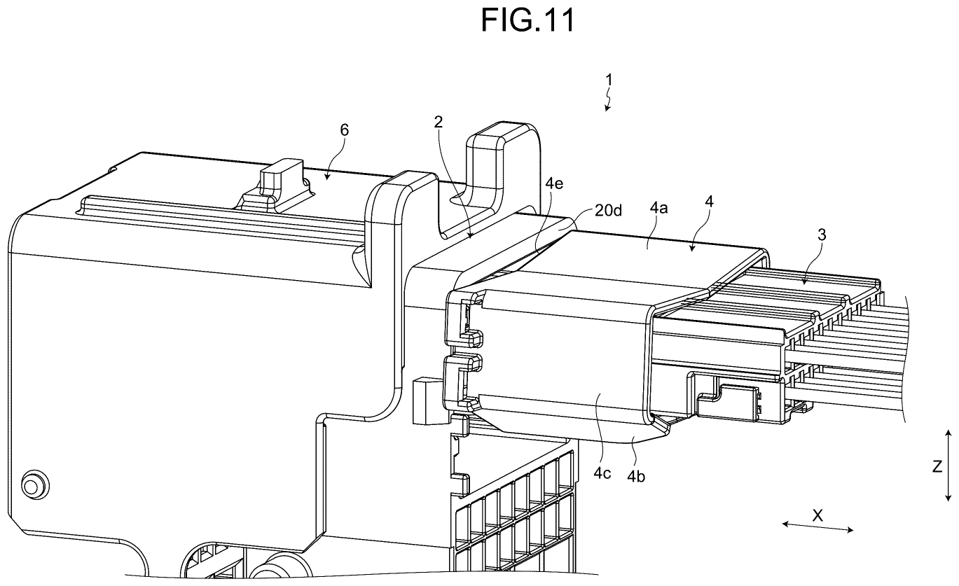

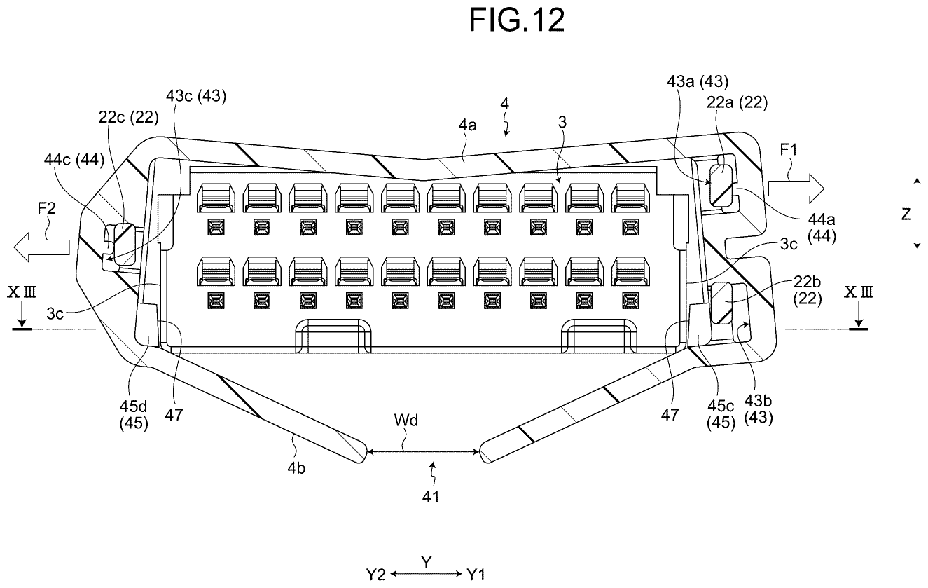

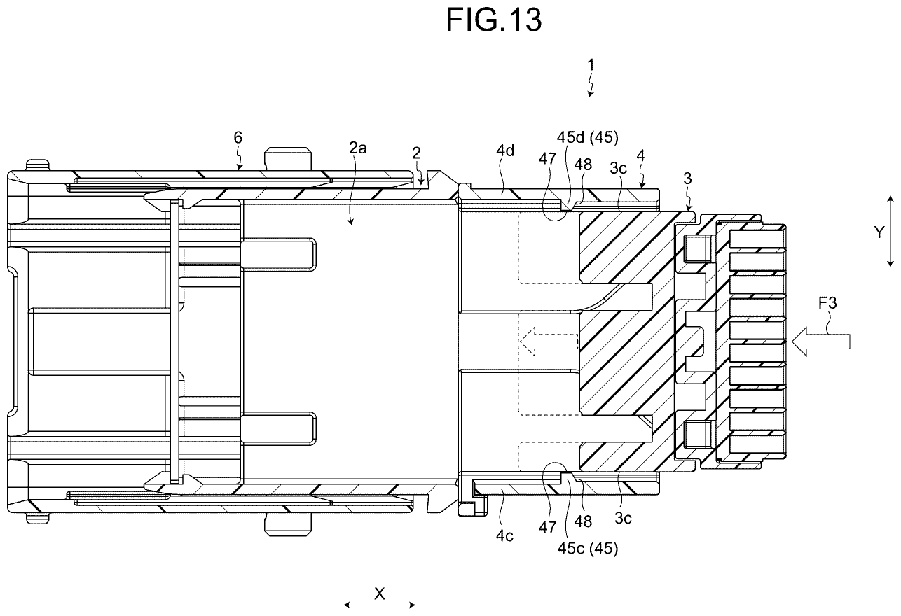

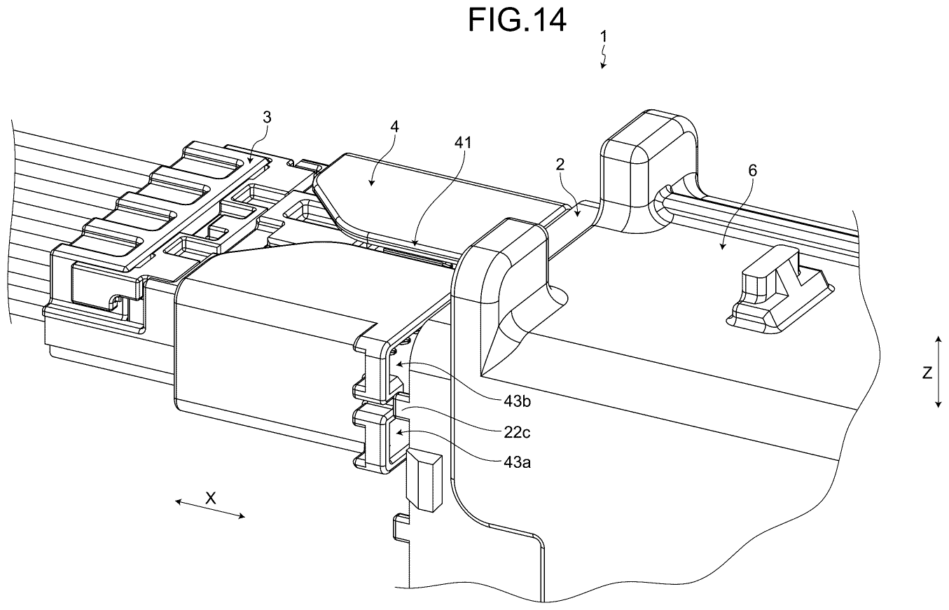

FIG. 11 is a perspective view of the detaching step of the embodiment, FIG. 12 is a sectional view of the protective cover deformed, FIG. 13 illustrates a section of a connector inserting step of the embodiment, and FIG. 14 is a diagram illustrating the frame restricting incorrect insertion of the connector housing. FIG. 6 illustrates a section taken along VI-VI in FIG. 5. FIG. 12 illustrates a section taken along XII-XII in FIG. 10. FIG. 13 illustrates a section taken along XIII-XIII in FIG. 12.

As illustrated in FIGS. 1 and 2, a connector 1 according to the embodiment includes a frame 2, a connector housing 3, a protective cover 4, and male terminals 5. The frame 2 is assembled to a hood 6. The hood 6 is a tubular member and holds the connector 1 and a mating connector. The mating connector includes a female terminal connected to the male terminals 5. The mating connector is fitted to the hood 6, thereby connecting to the connector 1.

As illustrated in FIG. 2, the connector housing 3 and a plurality of the male terminals 5 compose a sub-connector 10. To each of the male terminals 5, an electric wire W is connected. As illustrated in FIG. 1, the connector 1 and a plurality of the electric wires W compose a wire harness WH. The frame 2 of this embodiment is configured to be capable of accommodating a plurality of the sub-connectors 10.

As illustrated in FIG. 1, the sub-connector 10 and the protective cover 4 compose a unit 11 for assembly. The protective cover 4 is a member that is fitted to the connector housing 3 before assembled to the frame 2 and that protects tab portions 51 of the male terminals 5. As described below, the connector 1 of this embodiment is configured to detach the protective cover 4 from the connector housing 3 when the connector housing 3 is inserted into the frame 2.

In this specification, the inserting direction of the connector housing 3 relative to the frame 2 is referred to as “first direction X”. The width direction of the connector 1 is referred to as “second direction Y”, and the height direction of the connector 1 as “third direction Z”. The second direction Y and the third direction Z are orthogonal to the first direction X. The third direction Z is an arranging direction of a plurality of the connector housings 3 in the frame 2. The second direction Y and the third direction Z are orthogonal to each other.

The frame 2 is, for example, molded from an insulating synthetic resin. As illustrated in FIG. 3, the frame 2 is a member having a square tube shape and includes a plurality of accommodating chambers 2a. To be more specific, the frame 2 includes an outer wall 20 having a substantially rectangular section and a partitioning wall 21. The outer wall 20 includes side walls 20a and 20b facing each other in the second direction Y.

Inside the outer wall 20, the partitioning wall 21 forms the accommodating chambers 2a. The partitioning wall 21 is a wall portion orthogonal to the third direction Z and connects the side wall 20a to the side wall 20b. That is, the accommodating chambers 2a are formed in line in the third direction Z. Inner wall surfaces of the accommodating chambers 2a are provided with locking pieces 20c locking the connector housings 3. The locking pieces 20c are arm-like engaging portions extending in the first direction X. The locking pieces 20c are disposed on each of the side walls 20a and 20b.

The frame 2 includes guiding portions 22 for positioning that are disposed at an entrance of each of the accommodating chambers 2a. The guiding portions 22 are positioning ribs determining the position of the connector housing 3 relative to the accommodating chamber 2a. The guiding portions 22 are protrusions protruding from an end surface 20d of the outer wall 20 in the first direction X. The connector housing 3 is inserted into the accommodating chamber 2a from the end surface 20d side. The guiding portions 22 are disposed on each of the two side walls 20a and 20b. That is, the frame 2 includes the guiding portions 22 for positioning at both ends in the second direction Y. The guiding portions 22 of this embodiment have a prismatic shape.

In the frame 2 of this embodiment, the number of the guiding portions 22 disposed on one side wall 20a differs from the number of the guiding portions 22 disposed on the other side wall 20b. This prevents incorrect insertion of the connector housing 3 into the accommodating chamber 2a. Furthermore, the positions of the guiding portions 22 on the one side wall 20a differ from the position of the guiding portion 22 on the other side wall 20b. This prevents incorrect insertion of the connector housing 3 into the accommodating chamber 2a.

The guiding portions 22 include a first guiding portion 22a, a second guiding portion 22b, and a third guiding portion 22c. As illustrated in FIG. 3, the one side wall 20a is provided with two guiding portions 22a and 22b. The two guiding portions 22a and 22b are disposed at both ends of the accommodating chamber 2a in the third direction Z. The other side wall 20b is provided with one guiding portion 22c. The guiding portion 22c is disposed in a center of the accommodating chamber 2a in the third direction Z. The guiding portion 22c is disposed between the two guiding portions 22a and 22b in the third direction Z.

As illustrated in FIG. 2, the connector housing 3 has a substantially cuboid shape. The connector housing 3 is, for example, molded from an insulating synthetic resin. The connector housing 3 includes a plurality of through holes 3a holding the male terminals 5. The through holes 3a penetrate the connector housing 3 in the first direction X. The through holes 3a are aligned in the second direction Y and the third direction Z.

The connector housing 3 includes engaging protrusions 31 and a locking portion 32. The engaging protrusions 31 engage with the locking pieces 20c of the frame 2. The engaging protrusions 31 protrude from side surfaces, facing in the second direction Y, of the connector housing 3. The locking portion 32 locks the protective cover 4 and determines the position of the protective cover 4 relative to the connector housing 3. The locking portion 32 is disposed on a top surface 3b, facing in the third direction Z, of the connector housing 3. The locking portion 32 is a level difference formed on the top surface 3b and faces in the first direction X.

As illustrated in FIG. 2, the protective cover 4 is a tubular member. The protective cover 4 is, for example, molded from an insulating synthetic resin. The protective cover 4 of this embodiment is formed to have a square tube shape having a substantially rectangular section. The protective cover 4 includes a pair of facing walls 4a and 4b and a pair of side walls 4c and 4d.

The facing walls 4a and 4b are walls in the longer direction in the rectangular section of the protective cover 4. The facing walls 4a and 4b face each other in the third direction Z when the connector housing 3 is inserted into the accommodating chamber 2a. The side walls 4c and 4d are walls in the shorter direction in the rectangular section of the protective cover 4. The side walls 4c and 4d face each other in the second direction Y when the connector housing 3 is inserted into the accommodating chamber 2a.

As illustrated in FIGS. 2 and 4, one facing wall 4b of the protective cover 4 includes a slit-like opening 41. The opening 41 is disposed in a center of the facing wall 4b and divides the facing wall 4b into two parts. That is, the section of the protective cover 4 of this embodiment has such a shape that a rectangular is partially broken and open. The exemplified section of the protective cover 4 has a substantially C shape. The opening 41 extends in the first direction X being the inserting direction of the connector housing 3 relative to the frame 2.

The protective cover 4 is deformable to widen the opening width of the opening 41. This deformation is such that the side walls 4c and 4d move away from each other as illustrated by the two arrows AR1 in FIG. 4. The protective cover 4 is configured to be detached from the connector housing 3 by this deformation.

One facing wall 4a is provided with an abutting portion 42. The abutting portion 42 is locked by the locking portion 32 of the connector housing 3. The abutting portion 42 protrudes from the one facing wall 4a toward the other facing wall 4b. The abutting portion 42 is disposed in a center of the facing wall 4a in the second direction Y.

As illustrated in FIG. 4, a tip 4e of the protective cover 4 is provided with groove portions 43 into which the guiding portions 22 of the frame 2 are inserted. The tip 4e is a portion facing the end surface 20d of the frame 2 when the connector housing 3 is inserted into the frame 2. The groove portions 43 extend in the first direction X and are open toward the inner space of the protective cover 4. The sections of the groove portions 43 have such a shape that guiding of the groove portions 43 by the guiding portions 22 can determine the position of the connector housing 3 relative to the frame 2. The sectional shape of the groove portions 43 of this embodiment is substantially rectangular.

In the protective cover 4, the number of the groove portions 43 disposed corresponds to the number of the guiding portions 22. The groove portions 43 include a first groove portion 43a, a second groove portion 43b, and a third groove portion 43c. As illustrated in FIG. 4, on one side wall 4c, two groove portions 43a and 43b are disposed. The groove portions 43a and 43b respectively correspond to the guiding portions 22a and 22b of the frame 2. On the other side wall 4d, one third groove portion 43c is disposed. The third groove portion 43c corresponds to the guiding portion 22c of the frame 2.

The protective cover 4 includes releasing ribs 44 disposed in the groove portions 43. The releasing ribs 44 are formed to come into contact with the guiding portions 22 when the guiding portions 22 are inserted into the groove portions 43. In other words, the releasing ribs 44 are provided interfering with the paths of the guiding portions 22 in the groove portions 43. The releasing ribs 44 are ribs that deform the protective cover 4 to widen the opening width of the opening 41 and that detach the protective cover 4 from the connector housing 3. The releasing ribs 44 are disposed at ends of the groove portions 43 in the second direction Y. In other words, the releasing ribs 44 are disposed on bottom surfaces of the groove portions 43 dented toward the second direction Y.

The releasing ribs 44 include a releasing rib 44a disposed in the first groove portion 43a and a releasing rib 44c disposed in the third groove portion 43c. That is, the protective cover 4 includes the releasing ribs 44 at both ends in the second direction Y. The releasing ribs 44 are disposed in centers of the groove portions 43 in the third direction Z and extend in the first direction X. The third direction Z is a direction of the groove widths of the groove portions 43. End surfaces 44s of the releasing ribs 44 incline so that the releasing ribs 44 can go up onto the guiding portions 22.

The protective cover 4 includes locking portions 45 locking the connector housing 3 in the first direction X. As illustrated in FIGS. 2 and 4, the locking portions 45 include a first locking portion 45c disposed on the side wall 4c and a second locking portion 45d disposed on the side wall 4d. As illustrated in FIG. 2, the first locking portion 45c is disposed at a corner where the side wall 4c intersects with the facing wall 4b. As illustrated in FIG. 4, the second locking portion 45d is disposed at a corner where the side wall 4d intersects with the facing wall 4b.

As illustrated in FIG. 2, each of the locking portions 45 includes a supporting surface 47 and a locking surface 48. The locking surface 48 is a surface locking an end surface 3d of the connector housing 3. The end surface 3d is a surface facing the accommodating chamber 2a when the connector housing 3 is inserted into the frame 2. The supporting surface 47 is a surface supporting a side surface 3c of the connector housing 3 when the protective cover 4 is detached from the connector housing 3. The protective cover 4 supports the connector housing 3 from both sides in the second direction Y by using the supporting surfaces 47 and restricts misalignment of the connector housing 3.

The supporting surfaces 47 of this embodiment are inclining surfaces inclining relative to the side walls 4c and 4d. To be more specific, the supporting surface 47 of the first locking portion 45c inclines relative to the side wall 4c so as to be located away from the side wall 4c from the facing wall 4a side toward the facing wall 4b side. The supporting surface 47 of the second locking portion 45d inclines relative to the side wall 4d so as to be located away from the side wall 4d from the facing wall 4a side toward the facing wall 4b side. The protective cover 4 is configured so that the two supporting surfaces 47 are parallel to each other when the protective cover 4 is deformed to be detached from the connector housing 3.

A method of manufacturing the connector according to this embodiment will be described. The method of manufacturing the connector includes the cover fitting step, the terminal inserting step, the positioning step, the detaching step, and the connector inserting step.

The cover fitting step is a step of fitting the protective cover 4 to the connector housing 3. The cover fitting step is performed by, for example, a worker. At the cover fitting step, the connector housing 3 is inserted into the protective cover 4 as illustrated in FIG. 5. FIG. 6 illustrates a state in which the cover fitting step is completed. The connector housing 3 is inserted into the protective cover 4 while the end surface 3d is on the front side. The connector housing 3 is inserted into the protective cover 4 until the abutting portion 42 of the protective cover 4 engages with the locking portion 32. When the abutting portion 42 engages with the locking portion 32, the cover fitting step is completed.

The locking portions 45 of the protective cover 4 face the end surface 3d of the connector housing 3 in the first direction X and lock the end surface 3d. That is, the abutting portion 42 and the locking portions 45 determine the position of the protective cover 4 relative to the connector housing 3. The locking portions 45 restrict movement of the connector housing 3 toward a first side X1 in the first direction X. The first side X1 is a far side in the inserting direction when the connector housing 3 is inserted into the protective cover 4. The abutting portion 42 restricts movement of the connector housing 3 toward a second side X2 in the first direction X. The second side X2 is opposite the first side X1.

The protective cover 4 fitted to the connector housing 3 defines an accommodating space 46 for accommodating the tab portions 51 of the male terminals 5. The accommodating space 46 is a space on the first side X1 relative to the end surface 3d of the connector housing 3.

The terminal inserting step is performed after the cover fitting step. The terminal inserting step is performed by, for example, a worker. As illustrated in FIG. 7, each of the male terminals 5 includes the tab portion 51 and a joint portion 52. The tab portion 51 is a portion inserted into the mating female terminal and connected to the female terminal. The joint portion 52 is a portion joined to a core wire of the electric wire W. The joint portion 52 is, for example, pressure-bonded to the core wire. At the terminal inserting step, the male terminal 5 is inserted into the through hole 3a of the connector housing 3 while the tab portion 51 is on the front side. The male terminal 5 is inserted into the through hole 3a to a position where the tab portion 51 protrudes from the end surface 3d, and is held by the through hole 3a.

FIG. 8 illustrates a state in which the terminal inserting step is completed. The tab portions 51 of the male terminals 5 are accommodated in the accommodating space 46 defined by the protective cover 4. The protective cover 4 protects the tab portions 51 so that another device or equipment does not come into contact with the tab portions 51.

The positioning step is performed after the terminal inserting step. The positioning step is performed by, for example, a worker. The positioning step is a step of determining the position of the protective cover 4 and the connector housing 3 relative to the frame 2. As illustrated in FIG. 9, the position of the protective cover 4 and the connector housing 3 is determined relative to the frame 2. To be more specific, the position of the protective cover 4 and the connector housing 3 is determined so that the tip 4e of the protective cover 4 faces the end surface 20d of the frame 2. As illustrated in FIG. 9, the position of the protective cover 4 at this time is such that the first groove portion 43a faces the first guiding portion 22a and that the second groove portion 43b faces the second guiding portion 22b. Thus, the third groove portion 43c faces the third guiding portion 22c.

At the positioning step, the worker moves the protective cover 4 from the position illustrated in FIG. 9 toward the frame 2 in the first direction X. This inserts each of the guiding portions 22a, 22b, and 22c into the corresponding one of the groove portions 43a, 43b, and 43c. The guiding portions 22 are inserted into the groove portions 43, so that the position of the protective cover 4 and the connector housing 3 is determined. The position of the connector housing 3 at this time is such that the connector housing 3 faces the accommodating chamber 2a of the frame 2 and can be inserted into the accommodating chamber 2a.

The detaching step is performed after the positioning step. The detaching step is performed by, for example, a worker. The detaching step is a step of detaching the protective cover 4 from the connector housing 3. When the guiding portions 22 are inserted far into the groove portions 43, the guiding portions 22 come into contact with the releasing ribs 44 to deform the protective cover 4.

FIGS. 10 and 11 illustrate the deformed protective cover 4. At this time, the tip 4e of the protective cover 4 abuts on the end surface 20d of the frame 2. That is, until the tip 4e of the protective cover 4 abuts on the end surface 20d of the frame 2, the guiding portions 22 deform the protective cover 4.

FIG. 12 illustrates the deformed protective cover 4. As illustrated in FIG. 12, the first guiding portion 22a comes into contact with the releasing rib 44a of the first groove portion 43a. The first guiding portion 22a applies pressing force F1 toward a first side Y1 in the second direction Y, to the releasing rib 44a. On the other hand, the third guiding portion 22c comes into contact with the releasing rib 44c of the third groove portion 43c. The third guiding portion 22c applies pressing force F2 toward a second side Y2 in the second direction Y, to the releasing rib 44c.

The two types of pressing force F1 and F2 deform the protective cover 4 to widen the opening width Wd of the opening 41. This deformation is such that the facing wall 4a is bent toward the other facing wall 4b side. In other words, the guiding portions 22a and 22c deform the protective cover 4 so that the two locking portions 45c and 45d of the protective cover 4 move away from each other. This moves the two locking portions 45c and 45d to releasing positions. The releasing positions are such as not to lock the connector housing 3 and not to obstruct movement of the connector housing 3 to the frame 2.

The connector inserting step is performed after the detaching step. The connector inserting step is performed by, for example, a worker. The connector inserting step is a step of inserting the connector housing 3 into the accommodating chamber 2a of the frame 2.

With the protective cover 4 deformed at the detaching step, the worker applies pressing force F3 illustrated in FIG. 13 to the connector housing 3. The pressing force F3 is force of inserting the connector housing 3 into the accommodating chamber 2a. The connector housing 3 is inserted into the accommodating chamber 2a while sliding inside the protective cover 4 by the pressing force F3. At this time, the supporting surfaces 47 of the protective cover 4 support the connector housing 3 from both sides in the second direction Y. As illustrated in FIG. 12, when viewed from the first direction X, the supporting surfaces 47 of the locking portions 45 are located in the vicinities of the side surfaces 3c of the connector housing 3. That is, the two supporting surfaces 47 guard the connector housing 3 from both sides in the second direction Y so that the connector housing 3 is not misaligned in the second direction Y. The connector housing 3 is inserted to a position where the engaging protrusions 31 engage with the locking pieces 20c of the frame 2.

When the connector housing 3 is inserted into the accommodating chamber 2a, the protective cover 4 is completely detached from the connector housing 3. The worker collects the detached protective cover 4. At this time, the electric wires W pass through the opening 41 of the protective cover 4. The opening width of the opening 41 is set so as to allow at least the electric wires W to pass therethrough.

The connector 1 of this embodiment can prevent incorrect insertion of the connector housing 3 into the frame 2. FIG. 14 illustrates the connector housing 3 and the protective cover 4 that are about to be inserted into the frame 2 in a wrong orientation. The protective cover 4 illustrated in FIG. 14 is inverted from the protective cover 4 illustrated in FIG. 9. The first groove portion 43a and the second groove portion 43b of the protective cover 4 face the third guiding portion 22c of the frame. In this case, the third guiding portion 22c interferes with the protective cover 4. Similarly, at the end on the opposite side, the third groove portion 43c of the protective cover 4 faces the first guiding portion 22a and the second guiding portion 22b of the frame 2. The first guiding portion 22a and the second guiding portion 22b interfere with the protective cover 4. That is, if the protective cover 4 is inverted from the normal orientation, the guiding portions 22 cannot be inserted into the corresponding groove portions 43. This prevents incorrect insertion of the connector housing 3 into the frame 2.

As described above, the connector 1 of this embodiment includes the frame 2, the male terminals 5, the connector housing 3, and the tubular protective cover 4. The frame 2 includes the accommodating chambers 2a. The male terminals 5 include the tab portions 51. The connector housing 3 includes the through holes 3a holding the male terminals 5 while the tab portions 51 protrude. The connector housing 3 is inserted into one of the accommodating chambers 2a while the male terminals 5 are held. The protective cover 4 is fitted to the connector housing 3 before inserted into the accommodating chamber 2a. The protective cover 4 is detached from the connector housing 3 when the connector housing 3 is inserted into the accommodating chamber 2a.

The frame 2 includes the guiding portions 22 for positioning that are disposed at the entrance of the accommodating chamber 2a. The protective cover 4 includes the slit-like opening 41 extending in the inserting direction in which the connector housing 3 is inserted into the accommodating chamber 2a. The protective cover 4 is configured to be deformable to widen the opening width Wd of the opening 41.

The protective cover 4 includes the abutting portion 42 locked by the connector housing 3 in the inserting direction. The protective cover 4 defines the accommodating space 46 accommodating the tab portions 51 while fitted to the connector housing 3. The protective cover 4 includes the groove portions 43 into which the guiding portions 22 are inserted and the releasing ribs 44. The groove portions 43 are disposed at the tip 4e of the protective cover 4. The releasing ribs 44 are disposed in the groove portions 43 so as to come into contact with the guiding portions 22. The protective cover 4 is deformed by the pressing force F1 and F2 received by the releasing ribs 44 from the guiding portions 22 to widen the opening width Wd of the opening 41, thereby being detached from the connector housing 3.

With the connector 1 of this embodiment, the step of inserting the guiding portions 22 for positioning into the groove portions 43 of the protective cover 4 can not only determine the position of the connector housing 3 relative to the frame 2 but also detach the protective cover 4 from the connector housing 3. Thus, the connector 1 of this embodiment can improve workability of insertion of the connector housing 3 into the frame 2.

The protective cover 4 of this embodiment is deformed by the pressing force F1 and F2 received by the releasing ribs 44 from the guiding portions 22 to move the locking portions 45 to the releasing positions. The releasing positions of the locking portions 45 are such as not to lock the connector housing 3 and as to allow movement of the connector housing 3 to the accommodating chamber 2a. This configuration enables the connector housing 3 to move to the accommodating chamber 2a while the protective cover 4 remains abutting on the frame 2.

The protective cover 4 of this embodiment includes the two locking portions 45c and 45d. The two locking portions 45c and 45d are disposed on both sides of the protective cover 4 in the width direction relative to the opening 41. The two locking portions 45c and 45d guard the connector housing 3 moving to the accommodating chamber 2a from both sides in the width direction, thereby restricting misalignment of the connector housing 3. This configuration enables the connector housing 3 to have stable orientation and to be properly inserted into the accommodating chamber 2a.

Note that the shape of the protective cover 4 is not limited to the shape exemplified in the embodiment. For example, the number of the groove portions 43 disposed on the side wall 4c side may be the same as the number of the groove portions 43 disposed on the side wall 4d side. In this case, by misaligning the positions of the groove portions 43 on the side wall 4c from the positions of the groove portions 43 on the side wall 4d in the third direction Z, incorrect insertion of the connector housing 3 may be restricted.

The contents disclosed in the above-described embodiment can be combined and implemented as appropriate.

In the connector according to the present embodiment, the protective cover includes the groove portions into which the guiding portions for positioning are inserted, and the releasing ribs disposed in the groove portions so as to come into contact with the guiding portions. The protective cover is deformed by the pressing force received by the releasing ribs from the guiding portions to widen the opening width of the opening, thereby being detached from the connector housing. The connector according to the present invention achieves effect of improving workability of insertion of the connector housing while protecting the terminals.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a frame including an accommodating chamber;
a male terminal including a tab portion;
a connector housing including a through hole configured to hold the male terminal while the tab portion protrudes, the connector housing being configured to be inserted into the accommodating chamber while the male terminal is held; and
a tubular protective cover configured to be fitted to the connector housing before inserted into the accommodating chamber, and configured to be detached from the connector housing upon insertion of the connector housing into the accommodating chamber, wherein
the frame includes a guiding portion for positioning disposed at an entrance of the accommodating chamber,
the protective cover includes a slit-like opening extending in an inserting direction in which the connector housing is inserted into the accommodating chamber, and is configured to be deformable to widen an opening width of the opening,
the protective cover includes a locking portion configured to lock the connector housing in the inserting direction, and the protective cover defines an accommodating space configured to accommodate the tab portion while fitted to the connector housing,
the protective cover includes a groove portion disposed at a tip of the protective cover and into which the guiding portion is inserted, and a releasing rib disposed in the groove portion so as to come into contact with the guiding portion, and
the protective cover is configured to be deformed by pressing force received by the releasing rib from the guiding portion to widen the opening width of the opening, and detached from the connector housing.

2. The connector according to claim 1, wherein
the protective cover is configured to be deformed by the pressing force received by the releasing rib from the guiding portion to move the locking portion to a releasing position, and
the releasing position of the locking portion is a position not to lock the connector housing and to allow movement of the connector housing to the accommodating chamber.

3. The connector according to claim 2, wherein
the protective cover includes two locking portions,
the two locking portions are disposed on both sides of the protective cover in a width direction relative to the opening, and
the two locking portions are configured to guard, from both sides in the width direction, the connector housing moving to the accommodating chamber, and restrict misalignment of the connector housing.
